(19) United States
(12) Patent Application Publication
(10) Pub. No.: US 2022/0048388 A1
(43) Pub. Date: Feb. 17, 2022

(54) VEHICLE DISPLAY CLUSTER DISPLAY LENS

(71) Applicant: Stoneridge Electronics AB, Solna (SE)

(72) Inventor: Jon Möller, Sollentuna (SE)

(21) Appl. No.: 17/312,157

(22) PCT Filed: Dec. 13, 2018
(86) PCT No.: PCT/EP2018/084834

§ 371 Date: Jun. 9, 2021

(51) Int. Cl. B60K 35/00; G02F 1/1333

(52) U.S. Cl. CPC B60K 35/00; G02F 1/133331; B60K 2370/336; B60K 2370/332; B60K 2370/152

(57) ABSTRACT

A vehicle display assembly includes a display configured to depict information. A transparent lens is arranged over the display. An electrically conductive electrostatic discharge (ESD) element is arranged on the lens and configured to electrically bypass the display during an ESD event on the lens.

### BACKGROUND

This disclosure relates to a vehicle display assembly and, more particularly, this disclosure relates to an arrangement for grounding a lens of the display, such as those used in an instrument cluster or an infotainment display.

Vehicle displays, such as instrument clusters are widely used in passenger and commercial vehicles to convey vehicle information to the driver. Typical modem instrument clusters use a display, such as an LCD or other common type of display. The instrument cluster includes a protective lens arranged over the display.

An electrostatic discharge may be transmitted to the instrument cluster by the driver. In some instrument cluster configurations, electrical devices such as the display may be protected from an electrostatic discharge, which may be in excess of 15 kilovolts, for example.

### SUMMARY

In one exemplary embodiment, a vehicle display assembly includes a display configured to depict information. A transparent lens is arranged over the display. An electrically conductive electrostatic discharge (ESD) element is arranged on the lens and configured to electrically bypass the display during an ESD event on the lens.

In a further embodiment of the above, the ESD element may circumscribe the display.

In a further embodiment of any of the above, the display may have a display perimeter, and the ESD element may have an ESD perimeter arranged outside of the display perimeter.

In a further embodiment of any of the above, the lens may have a lens perimeter outside of the ESD perimeter.

In a further embodiment of any of the above, the display may have a frame supporting a display portion that may be configured to depict the information. The frame may be operatively attached to a carrier. The carrier may be mounted to a housing.

In a further embodiment of any of the above, the frame may be secured to the lens by, for example, an adhesive attachment.

In a further embodiment of any of the above, the adhesive attachment may be non-conductive to electrically insulate the lens from the display.

In a further embodiment of any of the above, the lens may be mounted to the housing.

In a further embodiment of any of the above, a printed circuit board (PCB) may be mounted to the carrier. The PCB may be in communication with the display and may be configured to provide the information.

In a further embodiment of any of the above, the ESD element may be attached between the lens and the carrier and may electrically interconnect the carrier to the lens. The carrier may be configured to be electrically connected to a ground.

In a further embodiment of any of the above, the lens may include a backside that faces the display. The backside may include an opaque masking material. The backside may have an unmasked portion surrounded by the masked material. The unmasked portion may correspond to an indicia. The indicia may be configured to be selectively illuminated to communicate a driver message.

In a further embodiment of any of the above, the vehicle display assembly may include a printed circuit board (PCB) in communication with a light source. The PCB may be configured to be in communication with a vehicle communications bus. The PCB may selectively illuminate the indicia in response to a vehicle state.

In a further embodiment of any of the above, the masking material may be conductive. The ESD element may be arranged on the masking material.

In a further embodiment of any of the above, the ESD element may be secured directly to the lens.

In another exemplary embodiment, an instrument cluster may include a housing. A carrier may be mounted to the housing. A display may have a display perimeter. The display may have a frame supporting a display portion that may be configured to graphically depict information. The frame may be operatively attached to the carrier. A transparent lens may be arranged over the display. The lens may include a backside that faces the display. The backside may include an opaque masking material. The backside may have an unmasked portion surrounded by the masked material. The unmasked portion may correspond to an indicia. The indicia may be configured to be selectively illuminated to communicate a driver message. A printed circuit board (PCB) may be mounted to the carrier. The PCB may be in communication with the display, and is configured to provide the information. An electrically conductive electrostatic discharge (ESD) element may be arranged on the lens outside of the display perimeter. The ESD element may be configured to be connected to a ground. The ESD element may be configured to electrically bypass the display during an ESD event on the lens.

In a further embodiment of any of the above, the frame may be secured to the lens by, for example, an adhesive attachment. The adhesive attachment may be non-conductive to electrically insulate the lens from the display.

In a further embodiment of any of the above, the ESD element may be attached between the lens and the carrier. The ESD element may electrically interconnect the carrier to the lens. The carrier may be configured to be electrically connected to the ground.

In a further embodiment of any of the above, the masking material may be conductive. The ESD element may be arranged on the masking material.

In a further embodiment of any of the above, the ESD element may be secured directly to the lens.

These and other features of the present disclosure can be best understood from the following specification and drawings, the following of which is a brief description.

### BRIEF DESCRIPTION OF THE DRAWINGS

The disclosure can be further understood by reference to the following detailed description when considered in connection with the accompanying drawings wherein:

FIG. 1 is a schematic view of an example vehicle instrument cluster.

FIG. 2 is another schematic view of a vehicle display for use as an instrument cluster shown in FIG. 1 with an electrostatic discharge (ESD) element used to convey an electrical charge during an ESD event to a vehicle ground.

FIG. 3 schematically illustrates a lens of the instrument cluster shown in FIG. 2 with a masking material and a configuration for selectively illuminating an indicia in the masking material.

FIG. 4 is one example ESD arrangement.

FIG. 5 is another ESD arrangement.

FIG. 6 is still another ESD arrangement.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### DETAILED DESCRIPTION

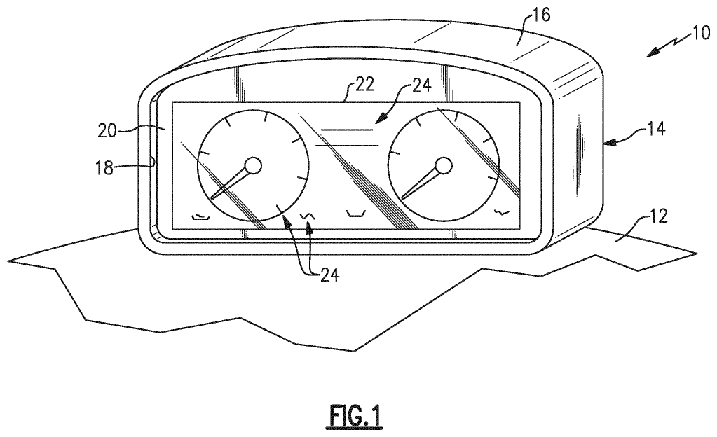

A vehicle 10 includes an interior 12 that typically has an instrument cluster 14, as shown in FIG. 1. The instrument cluster 14 may be arranged in a variety of configurations based upon various aesthetic and packaging considerations. Although the disclosed vehicle display assembly is described in more detail in connection with the instrument cluster 14, it should be understood that the vehicle display assembly may be used in other vehicle applications, such as an infotainment system.

The instrument cluster 14 includes a housing 16 having an opening 18 that is covered by a transparent lens 20. A display 22 is arranged within the housing 16 beneath the lens 20, which may be glass. The display 22, which may be an LCD, LED, OLED, or other type of display, conveys information 24 to the driver through the use of various graphics and text relating to a variety of vehicle operating conditions.

Referring to FIG. 2, the display 22 includes a display perimeter 26. A lens perimeter 28 of the lens 20 circumscribes the display perimeter 26. An electrically conductive electrostatic discharge (ESD) element 30 is arranged on the lens 20 and is configured to electrically bypass the display 22 during an ESD event on the lens 20. That is, the ESD element 30 diverts an electrostatic discharge to ground that might otherwise flow to the display instead. An example ESD event may be a driver picking up an electrostatic charge upon entry of the vehicle and then touching the lens 20.

The ESD element 30 may be one or more discrete electrical contacts, or, as shown in the example of FIG. 2, an unbroken conductive ring that circumscribes the display perimeter 26 to provide an ESD perimeter 32 outside of the display perimeter 26. The ESD element 30 is connected to a vehicle chassis ground 34 by an electrical connection 35. The vehicle chassis ground 34 is connected to a negative terminal of a battery 36 that provides the power source for various vehicle systems.

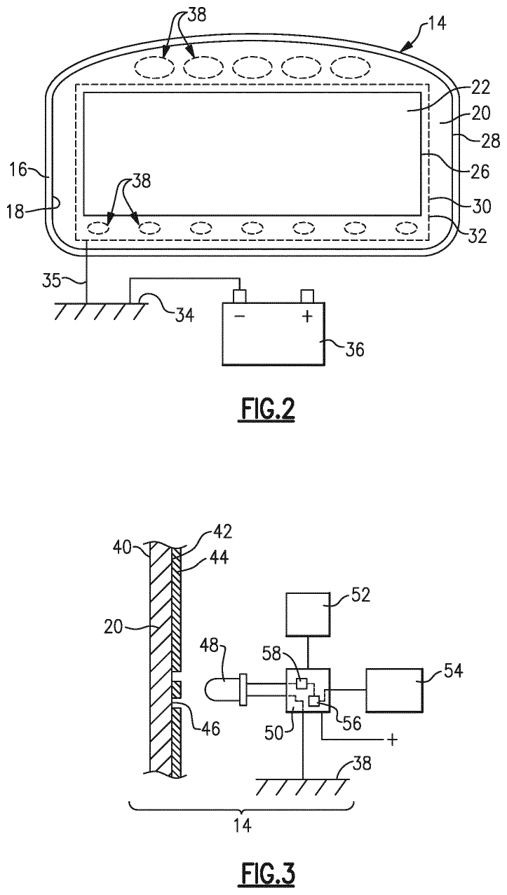

With continuing reference to FIG. 2, the lens 20 may include various indicia 38 that correspond to a variety of symbols and messages used to convey operational states of the vehicle or warnings to the driver. Often these indicia 38 are illuminated when initially starting the vehicle to indicate proper operation of the vehicle systems to the driver, after which the indicia 38 are no longer illuminated until a warning or change of vehicle system state occurs. Referring to FIG. 3, the lens 20 includes a front 40 and a backside 42. A masking material 44 is adhered to the backside 42. The masking material 44 may be provided by an opaque, black paint, for example. A portion of the backside 42 is left unmasked to provide an unmasked portion 46, and this unmasked portion corresponds to the indicia 38.

In one example, the instrument cluster 14 includes a printed circuit board (PCB) 50 to which a light 48, such as an LED, is mounted in alignment with the unmasked portion 46. The PCB 50 may be supported by a metal carrier 52 secured to the housing 16 and may also communication with the display 22 to provide information. A communications bus 54 (e.g., CAN, FlexRay, automotive Ethernet, etc.) communicates with the PCB 50 to convey vehicle information to the PCB 50 and its processor(s) 56. The PCB 50 may also include a switching device 58 that selectively illuminates the light 48 and its corresponding unmasked portion 46, thereby lighting the indicia 38.

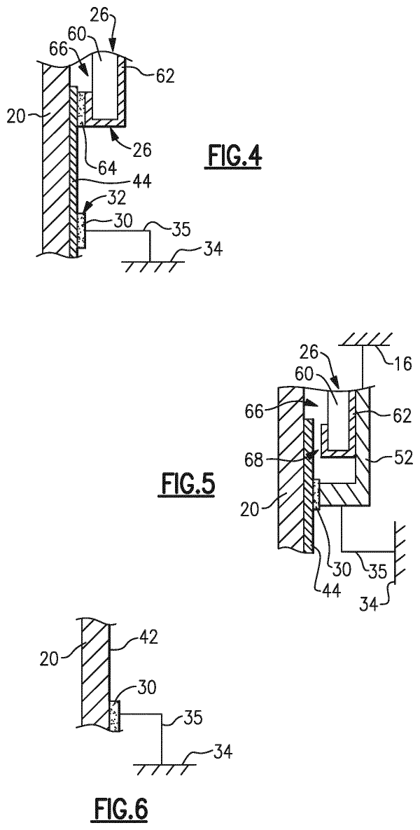

Turning to FIG. 4, the display 22 includes a display portion 60, or screen, which depicts the information 24. The display portion 60 is supported by a metal frame 62. An adhesive attachment 64 may be used to secure the frame 62 to the lens 20, and a gap 66 is provided between the display portion 60 and the lens 20. In the example, the masking material 44 extends inwardly and beyond the display perimeter 26 to cover the frame 62 and provide an aesthetically pleasing appearance to the driver. In such an arrangement, the adhesive attachment 64 adheres the frame 62 to the masking material 44. In one example, the adhesive attachment 64 may be provided by at least one of a gasket, an adhesive tape, or a glue, for example.

It may be desirable to provide a nonconductive adhesive attachment 64 to electrically insulate the lens 20 from the display 22. The ESD element 30 is secured to the masking material 44 if the masking material 44 is electrically conductive. In this manner, the lens 20 is electrically connected to the ground 34.

In the example shown in FIG. 5, the carrier 52 supports the frame 62 and is secured to the housing 16. Again, the masking material 44 may be of a conductive material. The ESD element 30 may be provided between the lens 20 and carrier 52, securing the components to one another and providing electrical continuity between the lens 20 and the ground 34. It may be desirable to provide a space 68 between the masking material 44 and the frame 62 to accommodate tolerance stack up issues between the components during assembly.

In the example shown in FIG. 6, the ESD element 30 may be electrically connected to the backside 42 of the lens 20 at a location without masking material 44. This may be desirable if an electrically nonconductive masking material is used.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

1. A vehicle display assembly comprising:
a display configured to depict information;
a transparent lens arranged over the display; and
wherein the lens includes a backside that faces the display, the backside includes an opaque masking material, the backside has an unmasked portion surrounded by the masked material that corresponds to an indicia, the indicia configured to be selectively illuminated to communicate a driver message.

2. The vehicle display assembly of claim 1, wherein an electrically conductive electrostatic discharge (ESD) element arranged on the lens and configured to electrically bypass the display during an ESD event on the lens.

3. The vehicle display assembly of claim 2, wherein the display has a display perimeter, and the ESD element has an ESD perimeter arranged outside of and circumscribing the display perimeter.

4. The vehicle display assembly of claim 3, wherein the lens has a lens perimeter outside of the ESD perimeter.

5. The vehicle display assembly of claim 1, wherein lens is glass, and the display has a frame supporting a display portion that is configured to depict the information, the frame operatively attached to a carrier mounted to a housing.

6. The vehicle display assembly of claim 5, wherein the frame is secured to the lens by an adhesive attachment.

7. The vehicle display assembly of claim 6, wherein the adhesive attachment is non-conductive to electrically insulate the lens from the display.

8. The vehicle display assembly of claim 6, wherein the lens is mounted to the housing.

9. The vehicle display assembly of claim 5, wherein a printed circuit board (PCB) is mounted to the carrier, the PCB is in communication with the display, and configured to provide the information, wherein the ESD element is attached between the lens and the carrier and electrically interconnects the carrier to the lens, the carrier configured to be electrically connected to a ground.

10-11. (canceled)

12. The vehicle display assembly of claim 1, comprising a printed circuit board (PCB) in communication with a light source, the PCB configured to be in communication with a vehicle communications bus and selectively illuminate the indicia in response to a vehicle state.

13. The vehicle display assembly of claim 2, wherein the masking material is conductive, and the ESD element is arranged on the masking material.

14. The vehicle display assembly of claim 2, wherein the ESD element is secured directly to the lens.

15. An instrument cluster comprising:
a housing;
a carrier mounted to the housing;
a display having a display perimeter, the display has a frame supporting a display portion that is configured to graphically depict information, the frame operatively attached to the carrier;
a transparent lens arranged over the display, the lens includes a backside that faces the display, the backside includes an opaque masking material, the backside has an unmasked portion surrounded by the masked material that corresponds to an indicia, the indicia configured to be selectively illuminated to communicate a driver message;
a printed circuit board (PCB) is mounted to the carrier, the PCB is in communication with the display, and configured to provide the information; and
an electrically conductive electrostatic discharge (ESD) element arranged on the lens outside of the display perimeter, and the ESD element is configured to be connected to a ground and to electrically bypass the display during an ESD event on the lens.

16. The instrument cluster of claim 15, wherein the frame is secured to the lens by an adhesive attachment, the adhesive attachment is non-conductive to electrically insulate the lens from the display.

17. The instrument cluster of claim 15, wherein the ESD element is attached between the lens and the carrier and electrically interconnects the carrier to the lens, the carrier configured to be electrically connected to the ground.

18. The instrument cluster of claim 15, wherein the masking material is conductive, and the ESD element is arranged on the masking material.

19. The instrument cluster of claim 15, wherein the ESD element is secured directly to the lens.
